(19) United States
(12) Patent Application Publication
(10) Pub. No.: US 2026/0317127 A1
(43) Pub. Date: Oct. 15, 2026

(54) TRACTION MACHINE, ELEVATOR SYSTEM, SHEAVE MAINTENANCE METHOD AND ASSEMBLY METHOD

(71) Applicant: Otis Elevator Company, Farmington, CT (US)

(72) Inventors: Guochen Gao, Tianjin (CN); Fengkun Zhu, Tianjin (CN); Hongliang Wu, Tianjin (CN)

(21) Appl. No.: 19/410,245

(22) Filed: Dec. 5, 2025

(30) Foreign Application Priority Data
Apr. 14, 2025 (CN) 202510464689.1

(51) Int. Cl. B66B 11/04

(52) U.S. Cl. CPC B66B 11/0438

(57) ABSTRACT

A traction machine, an elevator system, a sheave maintenance method, and an assembly method. The traction machine is used for an elevator system, and the traction machine includes: a housing; a rotating shaft partially disposed within the housing and axially extending outward through the housing; a first rolling bearing and a second rolling bearing fitted onto the rotating shaft; a sheave disposed within the housing and fitted around the rotating shaft, the sheave being used for connecting ropes of the elevator system, and the ropes being used for connecting an elevator car and a counterweight of the elevator system, the sheave is disposed between the first rolling bearing and the second rolling bearing.

### FOREIGN PRIORITY

This application claims priority to Chinese Patent Application No. 202510464689.1, filed Apr. 14, 2025, and all the benefits accruing therefrom under 35 U.S.C. § 119, the contents of which in its entirety are herein incorporated by reference.

### TECHNICAL FIELD

The present disclosure relates to the field of traction machines, and in particular to a traction machine, an elevator system, a sheave maintenance method, and an assembly method.

### BACKGROUND

This section is intended to provide background information relevant to understanding various technologies described herein. As the title of this section implies, this is a discussion of relevant technologies which should not in any way be implied as necessarily the prior art. Therefore, it should be understood that any statements in this section should be read in this light, and not as any acknowledgment of the prior art.

In some embodiments, a machine-room-less (MRL) pencil-type slender traction machine has a cantilever beam structure. The traction machine with a cantilever beam structure is a common form, as it is easy to manufacture and assemble, and also convenient for on-site sheave replacement. However, this type of traction machine may have a relatively large size and heavy weight, limited width, and larger bearings due to the characteristics of the cantilever beam. Additionally, since an inner rotor motor is used, the motor size is also relatively large.

### SUMMARY

The purpose of the present disclosure is to solve or at least alleviate the problems existing in the prior art.

According to one aspect, there is provided a traction machine for an elevator system, comprising:
a housing;
a rotating shaft partially disposed within the housing and axially extending outward through the housing;
a first rolling bearing and a second rolling bearing fitted onto the rotating shaft;
a sheave disposed within the housing and fitted around the rotating shaft, the sheave being used for connecting ropes of the elevator system, and the ropes being used for connecting an elevator car and a counterweight of the elevator system,
wherein the sheave is disposed between the first rolling bearing and the second rolling bearing.

Optionally, according to one embodiment of the present disclosure, the traction machine further comprises a stator with coils and a pulley with a magnet, wherein an end face of the housing is configured with a support portion axially extending inward, the stator is fitted onto the support portion, the pulley is fitted onto the rotating shaft and fixedly connected with the sheave, and the magnet is fitted around the stator.

Optionally, according to one embodiment of the present disclosure, the traction machine further comprises an end cover, wherein the end cover is snap-fit connected to the housing, the first rolling bearing is radially disposed between the end cover and the rotating shaft and axially disposed within the end cover, and the second rolling bearing is radially disposed between the housing and the rotating shaft and axially disposed within the housing.

Optionally, according to one embodiment of the present disclosure, the traction machine further comprises a coil brake comprising a friction disc and a movable plate, wherein the friction disc is fitted onto the rotating shaft and connected to the rotating shaft via splines, when the coil brake is energized, the friction disc is spaced apart from the movable plate, and when the coil brake is de-energized, the friction disc generates friction with the movable plate.

Optionally, according to one embodiment of the present disclosure, an end face of the sheave is provided with a sheave through-hole, an end face of the pulley is provided with a pulley blind hole, the sheave through-hole is aligned with the pulley blind hole, and a threaded fastener of the traction machine extends through the sheave through-hole into the pulley blind hole.

Optionally, according to one embodiment of the present disclosure, the traction machine further comprises an encoder, wherein the encoder is plug-connected to an end face of the rotating shaft, and the encoder is used to measure the rotational speed of the rotating shaft.

Optionally, according to one embodiment of the present disclosure, the end face of the housing facing the end cover is configured with a first stepped portion, and the end cover is snap-fit engaged with the first stepped portion.

Optionally, according to one embodiment of the present disclosure, the support portion is configured with a second stepped portion, the end of the rotating shaft away from the first rolling bearing is configured with a third stepped portion, and the second rolling bearing is radially disposed between the second stepped portion and the third stepped portion.

Optionally, according to one embodiment of the present disclosure, the end of the pulley facing the sheave is configured as a frame structure, wherein the frame structure comprises an axially extending hollow cylinder and a rib portion extending radially outward from the hollow cylinder to the inner circumferential surface of the pulley, and the rotating shaft is configured with a fourth stepped portion, with the hollow cylinder abutting against the fourth stepped portion.

Optionally, according to one embodiment of the present disclosure, the end of the rotating shaft facing the first rolling bearing is configured with a fifth stepped portion, with the first rolling bearing abutting against the fifth stepped portion.

Optionally, according to one embodiment of the present disclosure, the end cover comprises an end cover body and an accommodating portion extending axially inward and outward relative to the end cover body, wherein the axially outer part of the accommodating portion relative to the end cover body extends radially toward the rotating shaft, and the first rolling bearing is disposed within the accommodating portion, and the end cover further comprises a snap-fit portion extending axially inward from the end cover body, with the snap-fit portion snap-fit connected to the housing.

According to another aspect, there is provided an elevator system, wherein the elevator system comprises any one of the aforementioned traction machines.

According to a further aspect, there is provided a sheave maintenance method for the aforementioned traction machine, comprising the steps of:
extending a bolt via the housing into the pulley;
dismounting the end cover;
loosening the threaded fastener;
abutting a push rod of a sheave maintenance tool against an end face of the rotating shaft;
engaging an engaging bolt of the sheave maintenance tool into a maintenance hole provided on the end face of the sheave, and abutting the engaging bolt against the end face of the pulley via the maintenance hole; and
rotating the push rod, and pulling out the sheave.

Optionally, according to one embodiment of the present disclosure, the sheave maintenance method further comprises the steps of:
engaging the engaging bolt into the maintenance hole;
mounting the sheave onto the pulley;
loosening the engaging bolt and removing the sheave maintenance tool;
extending the threaded fastener through the sheave through-hole into the pulley blind hole;
mounting the end cover; and
removing the bolt.

According to yet another aspect, there is provided an assembly method for the aforementioned traction machine, comprising assembling a rotor assembly, assembling a stator assembly, and assembling the rotor assembly together with the stator assembly, wherein
the step of assembling the rotor assembly comprises:
assembling the sheave together with the pulley;
passing the rotating shaft through the sheave and the pulley;
mounting the first rolling bearing and the second rolling bearing onto the rotating shaft; and
mounting the end cover onto the first rolling bearing; and
the step of assembling the stator assembly comprises:
mounting the stator onto the support portion.

The traction machine according to the embodiments of the present disclosure has many advantages such as balanced load distribution, good stability, low vibration and noise, long service life, and high safety.

### BRIEF DESCRIPTION OF THE DRAWINGS

The content of the present disclosure will become easier to understand with reference to the drawings. It can be readily appreciated by a person skilled in the art that these drawings are for illustrative purposes only, and are not intended to limit the scope of protection of the present disclosure. In addition, similar numerals in the drawings denote similar components, wherein:

FIG. 1 is a schematic diagram of an exemplary elevator system;

FIG. 2 is a stereogram of a traction machine according to the present disclosure;

FIG. 3 is a sectional view of a traction machine according to the present disclosure;

FIG. 4 is a sectional view of a pulley according to the present disclosure;

FIG. 5 is a stereogram of a sheave according to the present disclosure;

FIG. 6 is a sectional view of a housing according to the present disclosure;

FIG. 7 is a stereogram of a rotating shaft according to the present disclosure;

FIG. 8 is a stereogram of a pulley according to the present disclosure;

FIG. 9 is a sectional view of an end cover according to the present disclosure;

FIG. 10 is a flow diagram of a sheave maintenance method according to the present disclosure;

FIG. 11 is a scenario of using a sheave maintenance tool according to the present disclosure;

FIG. 12 is a diagram illustrating the mating relationship between a sheave maintenance tool and a sheave according to the present disclosure;

FIG. 13 is a flow diagram of an assembly method according to the present disclosure;

FIG. 14 is an assembly diagram of a sheave and a pulley according to the present disclosure;

FIG. 15 is an assembly diagram of an assembly based on FIG. 14 and a rotating shaft according to the present disclosure;

FIG. 16 is an assembly diagram of an assembly based on FIG. 15 and a first rolling bearing and a second rolling bearing according to the present disclosure;

FIG. 17 is an assembly diagram of an assembly based on FIG. 16 and an end cover according to the present disclosure;

FIG. 18 is a stereogram of a stator according to the present disclosure;

FIG. 19 is a stereogram of a housing according to the present disclosure;

FIG. 20 is an assembly diagram of a stator and a housing according to the present disclosure;

FIG. 21 is an assembly diagram of a stator assembly and a rotor assembly according to the present disclosure;

FIG. 22 is a stereogram of an encoder according to the present disclosure;

FIG. 23 is a stereogram of a dual coil brake according to the present disclosure.

### DETAILED DESCRIPTION OF THE INVENTION

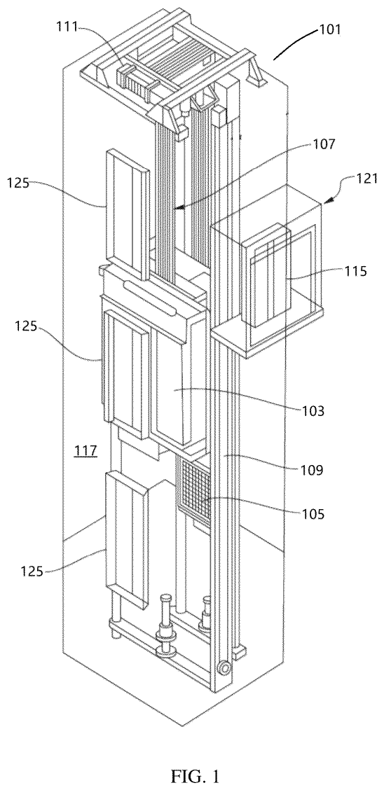

FIG. 1 is a perspective view of an elevator system 101, the elevator system comprising an elevator car 103, a counterweight 105, a cable 107, guide rails 109, a traction machine 111, and an elevator system controller 115. The elevator car 103 and the counterweight 105 are connected to each other via the cable 107. The cable 107 may comprise or be configured as, for example, a rope, a steel cable, and/or a coated steel belt. In this embodiment, the cable is configured as a cable belt integrating a plurality of cables. The counterweight 105 is configured as a load to balance the elevator car 103, and is configured to facilitate a synchronous opposite-direction movement of the elevator car 103 relative to the counterweight 105 within an elevator hoistway 117 and along the guide rails 109. The cable 107 engages with the traction machine 111, wherein the traction machine, as part of the top structure of the elevator system 101, is configured to control the movement between the elevator car 103 and the counterweight 105.

The elevator system controller 115, as shown, is positioned within an elevator system controller chamber 121 of the elevator hoistway 117 and is configured to control the operation of the elevator system 101, particularly the elevator car 103. For example, the elevator system controller 115 may provide drive signals to the traction machine 111 to control the acceleration, deceleration, leveling, stopping, etc., of the elevator car 103. When moving upward or downward along the guide rails 109 within the elevator hoistway 117, the elevator car 103, for example, under the control of the elevator system controller 115, may stop at one or more landings 125. Although shown positioned within the elevator system controller chamber 121, the elevator system controller 115 may be located and/or configured elsewhere within the elevator system 101, as those skilled in the art will appreciate. The traction machine 111 may comprise a motor or a similar drive mechanism.

While the cable system is illustrated and described, an elevator system employing other methods and mechanisms to move an elevator car within an elevator hoistway may also adopt the embodiments of the present disclosure. FIG. 1 is presented solely as a non-limiting example for illustrative and explanatory purposes.

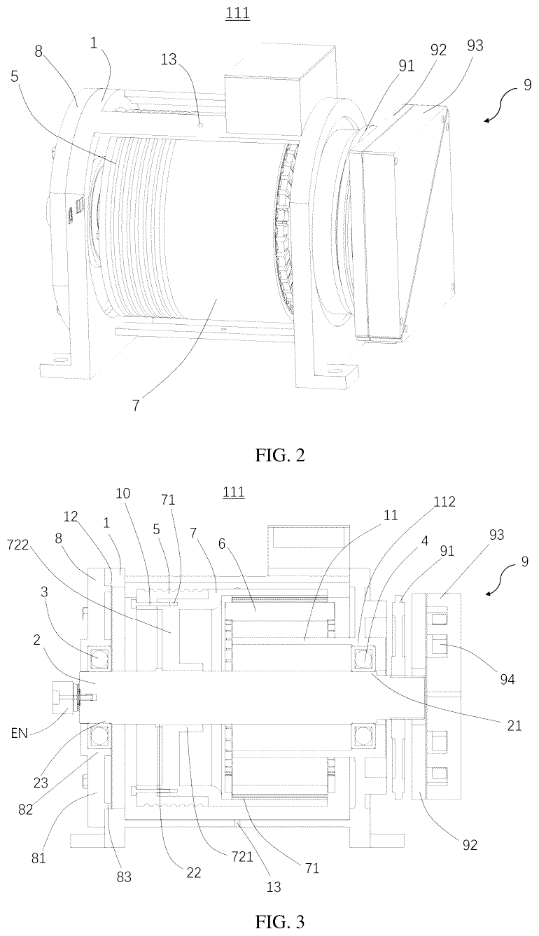

FIG. 2 is a stereogram of a traction machine according to the present disclosure; and FIG. 3 is a sectional view of a traction machine according to the present disclosure.

The traction machine 111 is used for an elevator system 101. The traction machine 111 comprises: a housing 1; a rotating shaft 2 partially disposed within the housing 1 and axially extending outward through the housing 1; a first rolling bearing 3 and a second rolling bearing 4 fitted onto the rotating shaft 2; a sheave 5 disposed within the housing 1 and fitted around the rotating shaft 2, the sheave 5 being used for connecting ropes 107 of the elevator system 101, and the ropes 107 being used for connecting an elevator car 103 and a counterweight 105 of the elevator system 101, wherein the sheave 5 is disposed between the first rolling bearing 3 and the second rolling bearing 4.

It should be understood that the sheave of the traction machine is used for laying ropes, such as steel ropes, the two ends of which are connected with a counterweight and an elevator car respectively. The ascent and descent process of the elevator car is accompanied by rotation of the sheave. As such, the overall system load is primarily borne by the sheave. In this connection, the present technical solution particularly specifies that the sheave is disposed between the first rolling bearing and the second rolling bearing, so that the traction machine is presented as a structure of a simply supported beam. The simply supported beam can provide compactness and light weight for the traction machine, and the rolling bearings (for example configured as ball bearings) can well engage with the structure of the simply supported beam. In particular, by means of the structural form of a simply supported beam, it is mainly up to the first rolling bearing and the second rolling bearing to jointly bear the system weight, and the weight distributed to each bearing is relatively small. In contrast, a cantilever beam primarily relies on the bearing located near the steel ropes to independently bear the entire system weight, while the bearing farther from the load of the system weight bears a small force. Thus, a cantilever beam typically uses a spherical roller bearing with a higher rated load and larger size, leading to higher costs. Conversely, the bearings applied to a simply supported beam have low rated loads, and ball bearings can be used, which have smaller sizes. The cost of two ball bearings can be significantly lower than that of a single spherical roller bearing. In addition, the effect of replacing a cantilever beam with a simply supported beam also includes overcoming the drawbacks of a long distance and excessive deflection between the load-bearing point of the cantilever beam and the motor's air gap.

Apart from the above, the sheave (traction sheave) is positioned in the middle, supported by bearings on both sides, which leads to a more balanced load distribution. This design avoids the issue of excessive force at a single point, thereby enhancing the overall stability of the traction machine, reducing wear and fatigue on components, prolonging the service life of the traction machine, and lowering maintenance costs. The simply supported beam structure also facilitates reducing vibration produced during the operation, lowering the noise level, and enabling the traction machine to operate more stably.

On the other hand, the design of the rotating shaft and the housing makes the structure of the traction machine relatively compact, facilitating installation and arrangement within the elevator system (the traction machine, for example, can be disposed on a machine-room-less beam via the housing). For this purpose, the housing is presented in the form of a supporting seat to facilitate installation of the traction machine, and the housing is of a hollow structure, so that the accommodating space formed by the housing can be fully utilized to provide a space utilization rate and compactness, in particular, enough space for dismounting and replacement of the sheave which serves as a consumptive part. Such design also takes into account the convenience of maintenance. For example, the internal components of the housing (such as a rotating shaft, rolling bearings, a sheave, etc.) can be easily observed and maintained. With the aforementioned technical solution, the overall deformation of the traction machine will also be reduced, particularly, the deformation of the sheave is effectively restrained. It should be understood that as the sheave is used for hanging ropes, deformation will affect the operation performance of the elevator car. In addition, deformation at the air gap of the motor is also reduced.

The traction machine 111 further comprises a stator 6 with coils and a pulley 7 with a magnet 71, wherein an end face of the housing 1 is configured with a support portion 11 axially extending inward, the stator 6 is fitted onto the support portion 11, the pulley 7 is fitted onto the rotating shaft 2 and fixedly connected with the sheave 5, and the magnet 71 is fitted around the stator 6.

This technical solution provides a refined design of the operating principle of the traction machine. It can be seen that when the stator's coils are energized, a rotating magnetic field will be generated. The electromagnetic effect generated between the coils and the surrounding magnet thereof causes the pulley to rotate, and the rotation of the pulley drives the rotation of the sheave and the rotating shaft respectively, wherein the rotation of the sheave is used to support the ascent and descent movement of the elevator car. The magnet is arranged, for example, uniformly on the inner circumferential surface of the pulley.

This technical solution further defines that the housing utilizes its support portion (which is configured, for example, as a hollow cylinder axially extending inward) to arrange the stator, and can provide a working space for a motor composed of the stator and the rotor in a compact manner. This ensures that the relative position between the stator and the rotor is fixed, thereby reducing vibration and friction in the operation process, and improving the efficiency of power transmission. It is particularly noteworthy that this type of motor is an outer rotor motor, characterized by a larger air gap diameter, a shorter iron core, and shorter ends of the stator copper wires compared with an inner rotor motor, especially when the shape width is restricted. In addition, the fit-on or fit-around design of these components makes the overall structure of the traction machine more compact, optimizing space utilization.

The traction machine 111 further comprises an end cover 8, wherein the end cover 8 is snap-fit connected to the housing 1, the first rolling bearing 3 is radially disposed between the end cover 8 and the rotating shaft 2 and axially disposed within the end cover 8, and the second rolling bearing 4 is radially disposed between the housing 1 and the rotating shaft 2 and axially disposed within the housing 1.

The snap-fit design of the end cover and the housing provides a stable structural framework for the traction machine, particularly offering protection for internal components of the traction machine. Only a left end of the rotating shaft, an encoder that will be introduced later, and a portion of the housing extend beyond the end cover.

The present technical solution further provides a refined design for the arrangement positions of the first and second rolling bearings. Among them, the arrangement method of the first rolling bearing ensures stable support for the rotating shaft at the end cover, reducing radial runout or displacement of the rotating shaft, while also providing effective protection for the first rolling bearing. Likewise, the arrangement method of the second rolling bearing provides an additional support point for the rotating shaft, further enhancing the stability and positioning accuracy of the rotating shaft, while also protecting the second rolling bearing by the housing. As for the characteristics of the rolling bearings per se, it can also be established that they can significantly reduce friction caused by direct contact between the rotating shaft and the housing or the end cover. Therefore, the noise and vibration in the operation process can be reduced, and the operation efficiency and service life of the traction machine can be improved as well.

The traction machine 111 further comprises a coil brake 9 comprising a friction disc 91 and a movable plate 92, wherein the friction disc 91 is fitted onto the rotating shaft 2 and connected to the rotating shaft 2 via splines, when the coil brake 9 is energized, the friction disc 91 is spaced apart from the movable plate 92, and when the coil brake 9 is de-energized, the friction disc 91 generates friction with the movable plate 92.

According to this technical solution, when braking is not required, the coil brake is energized, which attracts the movable plate and separates it from the friction disc. For example, the movable plate is attracted to a stationary plate 93 (the movable plate is positioned between the friction disc and the stationary plate), allowing the traction machine to operate normally. When braking is required, the brake is de-energized. The movable plate is pushed to engage frictionally with the friction disc, for example by the force of a spring (not shown) located between the movable plate and the stationary plate. The generated resistance to the frictional force of the friction disc and the spline connection between the friction disc and the rotating shaft cause this resistance to act on the rotating shaft, which in turn acts on the pulley and the sheave, ultimately producing a braking effect (including deceleration and stopping) on the elevator car.

This design makes the braking process of the traction machine more reliable and flexible, and can realize the control of the traction machine by controlling the energizing or de-energizing of the brake as needed. Meanwhile, the spline connection also ensures stable connection between the friction disc and the rotating shaft, improving stability and safety of braking.

Furthermore, the coil brake is configured as a dual coil brake. Exemplarily, it comprises two stationary plates, two coils 94, two movable plates, and one friction disc. The stationary plates provide accommodating spaces in which the coils are disposed, to respectively control the electromagnetic displacement of one of the movable plates. These two movable plates are collectively fitted around one end of the rotating shaft to enable more comprehensive braking of the friction disc, thereby improving the braking performance.

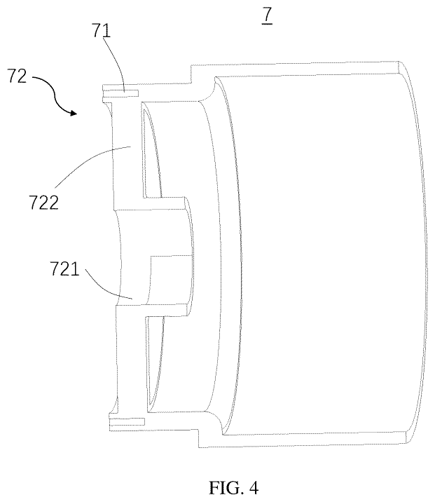

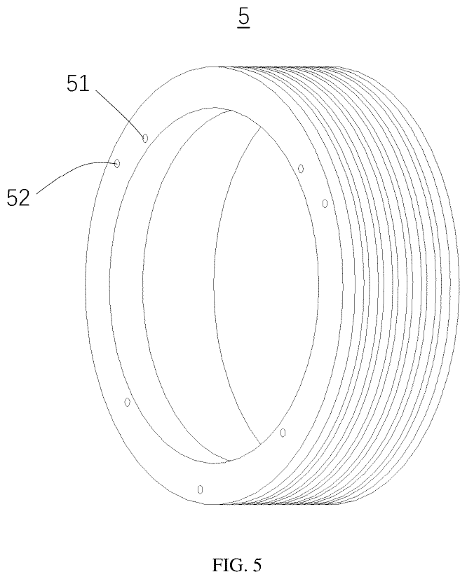

FIG. 4 is a sectional view of a pulley according to the present disclosure; and FIG. 5 is a stereogram of a sheave according to the present disclosure.

An end face of the sheave 5 is provided with a sheave through-hole 51, an end face of the pulley 7 is provided with a pulley blind hole 71, the sheave through-hole 51 is aligned with the pulley blind hole 71, and a threaded fastener 10 of the traction machine 111 extends through the sheave through-hole 51 into the pulley blind hole 71.

The threaded fastener should be understood in a broad sense, including threaded fixing elements such as bolts, cap screws, studs, screws, and the like. The present technical solution provides an example for the fixing mode between a sheave and a pulley. This way of connection is not only simple and reliable, but also can effectively transmit torque and force, ensuring synchronous rotation of the sheave and pulley in the operation process of the traction machine. Meanwhile, the threaded fastener, as a dismountable means of connection, also facilitates the dismounting and maintenance of the sheave and the pulley, and improves the maintainability and convenience of using the traction machine.

Also exemplarily, a plurality of sheave through-holes are provided; for example, four sheave through-holes are evenly distributed at equal angular intervals on the end face of the sheave, and the pulley blind holes are correspondingly disposed as well, thereby enhancing the stability of the fixation between the two components.

The traction machine 111 further comprises an encoder EN which is plug-connected to an end face of the rotating shaft 2, and the encoder EN is used to measure the rotational speed of the rotating shaft 2.

By measuring the rotational speed of the rotating shaft, the encoder indirectly measures the rotational speed of the sheave and the lifting speed of the elevator car. In terms of the assembly method, the encoder is inserted into the left end of the rotating shaft. Specifically, the encoder may be incremental or absolute. For example, the incremental encoder is mounted directly at the end of the shaft, and rotates together with the shaft. When the shaft rotates, an encoding disc or a grating inside the encoder rotates accordingly to generate pulse signals. These pulse signals can be used to accurately measure the rotational speed of the shaft through counting and calculation.

Therefore, the encoder's real-time measurement capability for rotational speed enables timely monitoring of the operating state of the traction machine, and improves control accuracy, for example, ensuring smooth and steady starts and stops, and precise landing of the elevator car. Based on such rotational speed feedback, the operating state of the traction machine can also be automatically adjusted, such as by regulating motor output power or optimizing operation curves, thereby enhancing the operation efficiency and safety of the traction machine. The rotational speed can also be utilized to detect potential faults or abnormal conditions (e.g., overload, jamming, etc.) It is also feasible that the measurement data of the encoder can be recorded and used for maintenance and management of the traction machine. By analyzing historical data, the operating state and wear conditions of the traction machine can be understood, allowing for the formulation of reasonable maintenance plans to extend the service life of the traction machine.

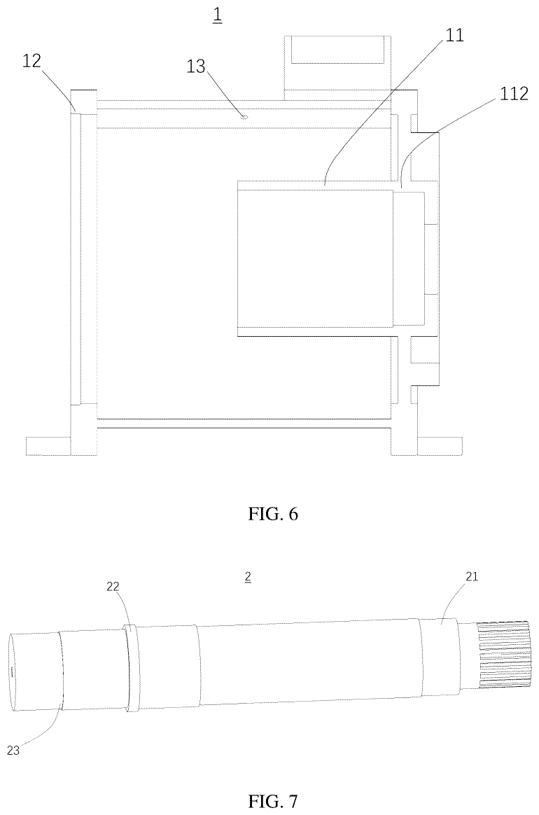

FIG. 6 is a sectional view of a housing according to the present disclosure.

The end face of the housing 1 facing the end cover 8 is configured with a first stepped portion 12, and the end cover 8 is snap-fit engaged with the first stepped portion 12.

The first stepped portion is exemplarily a recessed structure formed on the inner circumferential surface at the left end of the housing, facilitating a snap-fit connection with the corresponding part of the end cover. The snap-fit connection design provides a clear positioning reference for the installation of both components, and enables easy assembly, resulting in a tight mechanical connection between the end cover and the housing. When the end cover is snap-fit engaged with the first stepped portion, they are unlikely to separate radially, significantly enhancing the stability of the connection. This can effectively prevent loosening caused by vibration or impact, thereby ensuring long-term stable operation of the device. Furthermore, the concentricity between the end cover and the housing can be guaranteed.

FIG. 7 is a stereogram of a rotating shaft according to the present disclosure.

The support portion 11 is configured with a second stepped portion 112, the end of the rotating shaft 2 away from the first rolling bearing 3 is configured with a third stepped portion 21, and the second rolling bearing 4 is radially disposed between the second stepped portion 112 and the third stepped portion 21.

Therefore, in addition to providing support for the stator, the support portion cooperates with the third stepped portion to provide precise positioning and installation location for the second rolling bearing, particularly ensuring that the second rolling bearing is effectively fixed in the axial direction. This arrangement is simple and reliable, capable of withstanding relatively large axial loads and preventing axial displacement of the bearing during operation. Among them, the second stepped portion is a protrusion formed on the inner circumferential surface of the support portion, while the third stepped portion is a protrusion formed on the outer circumferential surface near the right end of the rotating shaft.

In addition, the second stepped portion and the third stepped portion provide additional bearing surface for the second rolling bearing, enhancing the loading capacity of the bearing. When the bearing is subjected to radial loads, it can receive more uniform and stable support, reducing faults caused by bearing loosening or positional deviations. This helps maintain the normal operating clearance of the bearing, and improves the rotational precision and stability of the bearing. Consequently, the service life of the bearing is extended.

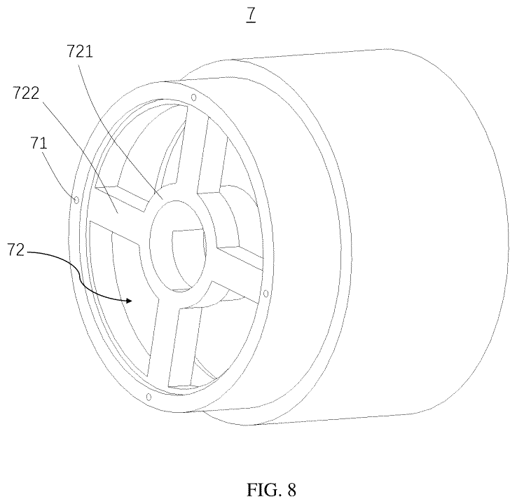

FIG. 8 is a stereogram of a pulley according to the present disclosure.

The end of the pulley 7 facing the sheave 5 is configured as a frame structure 72, wherein the frame structure 72 comprises an axially extending hollow cylinder 721 and a rib portion 722 extending radially outward from the hollow cylinder 721 to the inner circumferential surface of the pulley 7, and the rotating shaft 2 is configured with a fourth stepped portion 22, with the hollow cylinder 721 abutting against the fourth stepped portion 22.

Exemplarily, the fourth stepped portion is a protrusion formed on the outer circumferential surface near the left end of the rotating shaft. The shape of the frame structure resembles a hub, with the central cylinder used for the rotating shaft to pass through and engage. The assembly is quite easy, and the rib portion serves to enhance the structural strength.

Specifically, the hollow cylinder provides axial support, while the rib portion reinforces the support to the inner circumferential surface of the pulley, making the entire pulley more stable under load. In particular, the arrangement position of the rib portion supports the sheave that directly bears the system load, thereby enhancing load-bearing capacity. On the other hand, the fourth stepped portion allows the pulley to be securely installed on the rotating shaft, reducing the possibility of the pulley sliding on the rotating shaft, and improving the connection stability between the two.

The end of the rotating shaft 2 facing the first rolling bearing 3 is configured with a fifth stepped portion 23, with the first rolling bearing 3 abutting against the fifth stepped portion 23.

The fifth stepped portion is exemplarily a recessed structure formed at the left end of the rotating shaft. Likewise, the fifth stepped portion provides a stable mounting base for the first rolling bearing, making the installation process of the bearing easier and more precise. It prevents the bearing from being misaligned or tilted during installation, allowing the bearing to transmit torque and rotational speed more accurately, and reducing energy loss and transmission errors caused by bearing runout. In particular, it enables stable and high-strength arrangement of the first rolling bearing in cooperation with the end cover. The bearing directly abuts the stepped portion, reducing runout or displacement caused by unstable mounting, thereby improving the stability of the bearing on the rotating shaft.

It is also worth mentioning that for the housing, the first stepped portion, the support portion, and the second stepped portion can all be constructed in the same process; for the pulley, the pulley blind hole, the hollow cylinder, and the inner circumferential portion that supports the magnet can be constructed in the same process; the third, fourth and fifth stepped portions of the rotating shaft can be constructed in the same process; and the accommodating portion and the snap-fit portion of the end cover can be constructed in the same process. Thus, this manufacturing method can ensure structural manufacturing precision and further guarantee uniform air gaps in the motor. The present disclosure does not impose any particular limitations on the specific processes, and machining techniques (such as turning) are applicable.

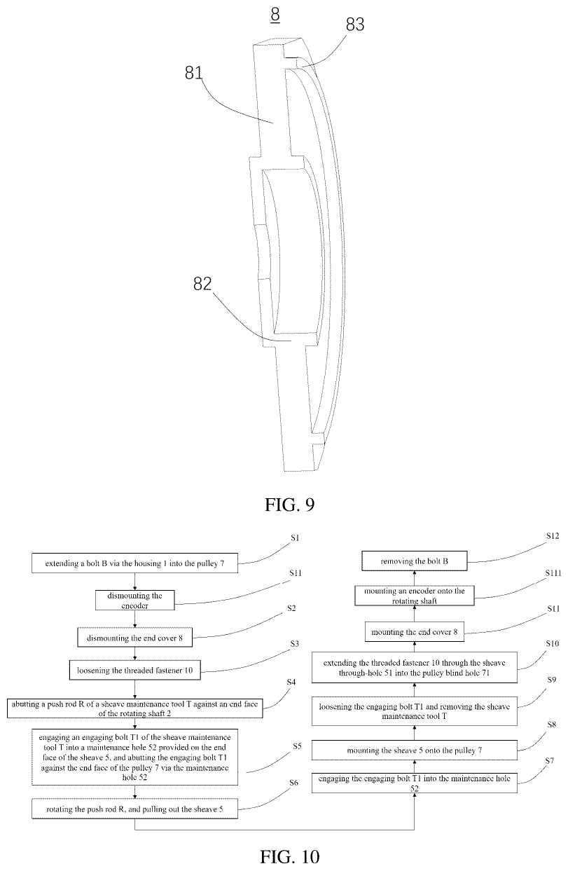

FIG. 9 is a sectional view of an end cover according to the present disclosure.

The end cover 8 comprises an end cover body 81 and an accommodating portion 82 extending axially inward and outward relative to the end cover body 81, wherein the axially outer part of the accommodating portion 82 relative to the end cover body 81 extends radially toward the rotating shaft 2, and the first rolling bearing 3 is disposed within the accommodating portion 82, and the end cover 8 further comprises a snap-fit portion 83 extending axially inward from the end cover body 81, with the snap-fit portion 83 snap-fit connected to the housing 1.

This technical solution features a targeted design of the end cover, wherein the accommodating portion not only provides accommodating space for the first rolling bearing, but also protects it from the outside. The snap-fit portion can corporates with the first stepped portion of the housing to achieve a snap-fit connection. The snap-fit design makes mounting and dismounting of the end cover more convenient and efficient, thereby improving maintenance efficiency and reducing maintenance costs. In addition, the end cover is exemplarily configured as a rotating body, such as a cylinder, or configured with linear cutouts on both sides of the cylinder to enhance compactness, and can better match and align with the shape of the end of the housing.

The present disclosure further relates to an elevator system 101, wherein the elevator system 101 comprises any one of the aforementioned traction machines 111. Thus, the elevator system of the present disclosure can incorporate various implementations and corresponding technical effects of the traction machine, which will not be repeated here.

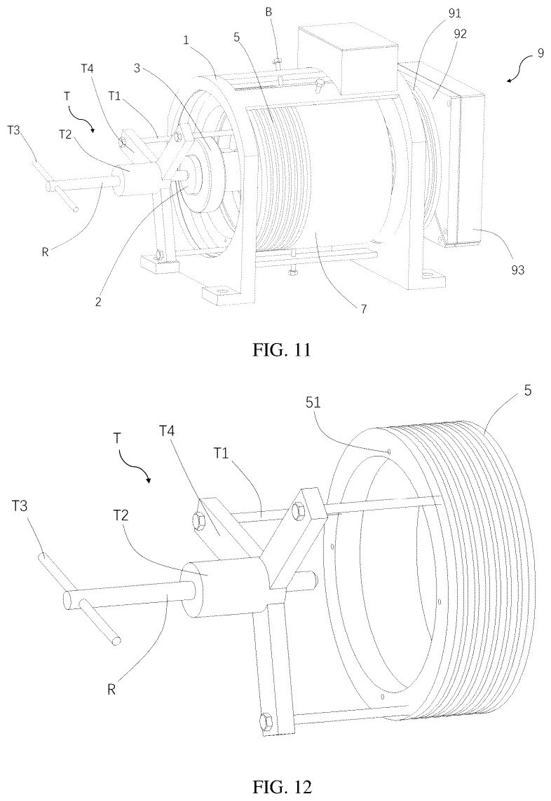

FIG. 10 is a flow diagram of a sheave maintenance method according to the present disclosure; FIG. 11 is a scenario of using a sheave maintenance tool according to the present disclosure; and FIG. 12 is a diagram illustrating the mating relationship between a sheave maintenance tool and a sheave according to the present disclosure.

The present disclosure still further relates to a sheave maintenance method for the traction machine 111, comprising the steps of:
S1: extending a bolt B via the housing 1 into the pulley 7;
S2: dismounting the end cover 8;
S3: Loosening the Threaded Fastener 10;
S4: abutting a push rod R of a sheave maintenance tool T against an end face of the rotating shaft 2;
S5: engaging an engaging bolt T1 of the sheave maintenance tool T into a maintenance hole 52 provided on the end face of the sheave 5, and abutting the engaging bolt T1 against the end face of the pulley 7 via the maintenance hole 52; and
S6: Rotating the Push Rod R, and Pulling out the Sheave 5.

Among them, the purpose of extending the bolt into the pulley is to brace against the pulley, thereby fixing the sheave and facilitating subsequent dismounting of the sheave. Therefore, the housing can be correspondingly provided with a threaded hole 13 to facilitate the bolt to pass through. The way of dismounting the end cover in step S2 depends on the specific means of connection of the end cover. For example, when the end cover is connected to the housing by threads, dismounting the end cover can be accomplished by loosening the threaded connector.

The sheave maintenance tool exemplarily includes a base T2, with the push rod arranged through the base, and an end of the push rod is connected to a handle structure T3 for ease of operation. The push rod can rotate and translate relative to the base. The outer periphery of the base is connected to or configured with several radially outward extending spokes T4, each of which is connected with an engaging bolt to facilitate corporation with the sheave. For this purpose, an end face of the sheave is provided with maintenance holes. Similar to the sheave through-holes, there can be several maintenance holes—for example, three—that are evenly distributed at equal angular intervals around the end face of the sheave. In order to avoid interference with the sheave through-holes, the maintenance holes and the sheave through-holes are positioned at different distances relative to the symmetric axis of the sheave, ensuring that the sheave maintenance tool can smoothly corporate with the maintenance holes.

In step S4, it is specified that the push rod abuts against an end face of the rotating shaft to provide support for the subsequent dismounting of the sheave. In step S5, it is specified that the engaging bolt can pass through the maintenance hole and abut against the end face of the pulley. As such, this can provide significant mechanical feedback to the maintenance personnel, indicating that the engaging bolt has been properly assembled and it is ready for the subsequent disassembly operation. Furthermore, in this case, the insertion depth of the engaging bolt into the sheave is as deep as possible, which offers robust support for the disassembly operation.

It should be appreciated that this method makes it easier for the dismounting and replacement of the sheave, which is a significant technical improvement for the traction machine that requires periodic maintenance or replacement of the sheave. The overall maintenance process is reasonably designed, and the steps are clear, capable of shortening the maintenance time and improving maintenance efficiency. Finally, the downtime of the traction machine is reduced.

In some other embodiments, if the traction machine comprises components such as an encoder, the sheave maintenance method may further comprise step S11 between S1 and S2, i.e., dismounting the encoder.

It is also feasible that the sheave maintenance method further comprises the steps of:
S7: engaging the engaging bolt T1 into the maintenance hole 52;
S8: mounting the sheave 5 onto the pulley 7;
S9: loosening the engaging bolt T1 and removing the sheave maintenance tool T;
S10: extending the threaded fastener 10 through the sheave through-hole 51 into the pulley blind hole 71;
S11: mounting the end cover 8; and
S12: Removing the Bolt B.

The above steps correspond to the assembly steps of a new sheave after the old sheave is removed, and can basically be interpreted as the reverse of the disassembly steps. Among them, if the traction machine further comprises an encoder, the method further comprises step S111 between S11 and S12, i.e., mounting an encoder onto the rotating shaft.

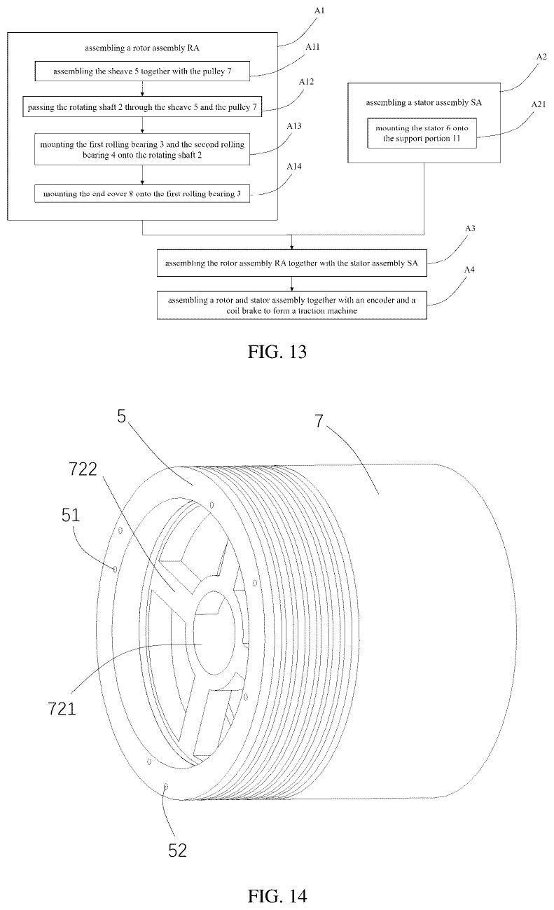

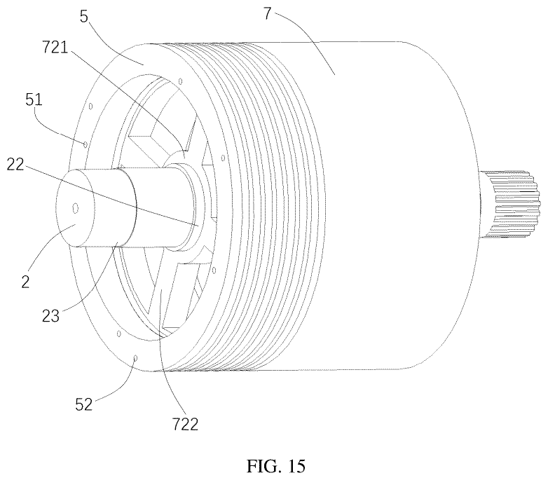

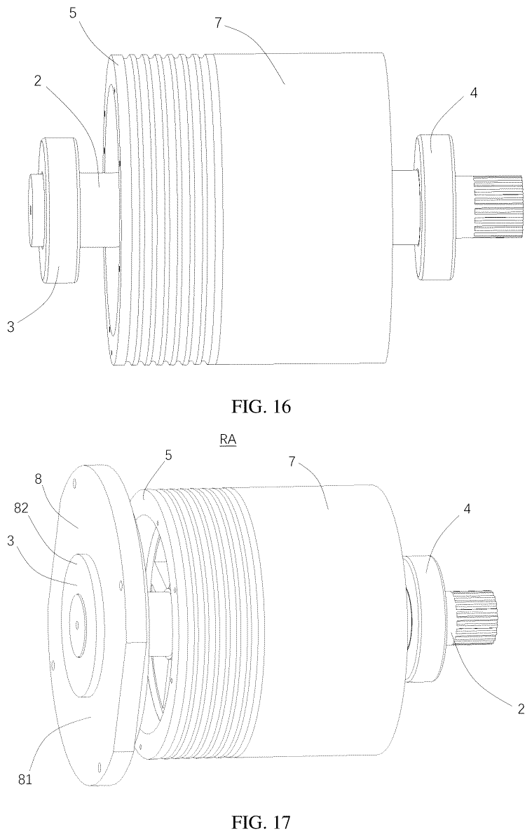

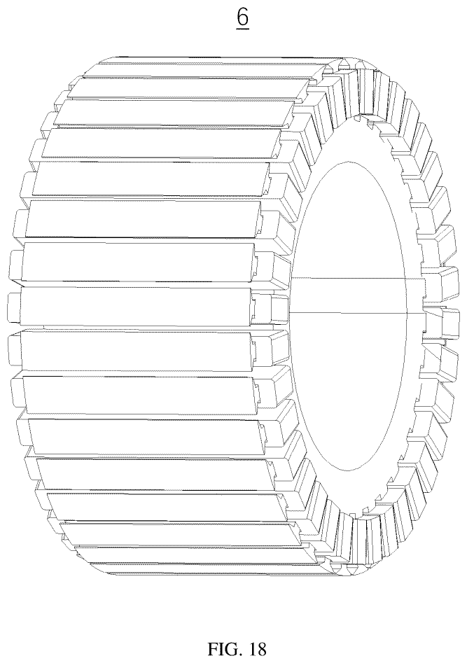

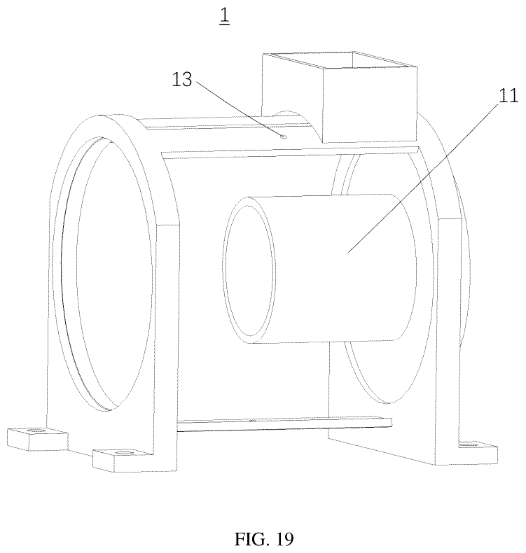

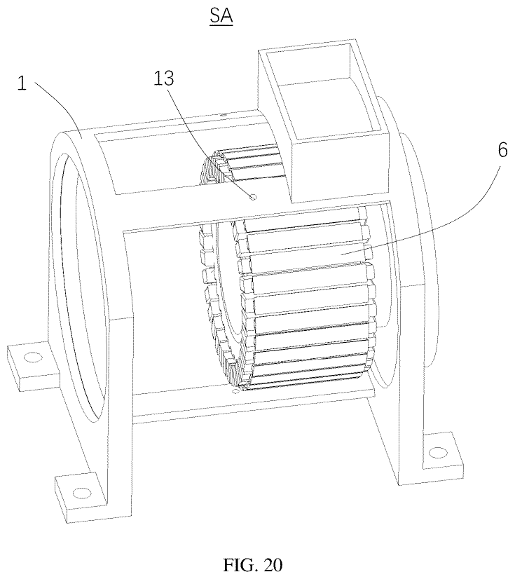

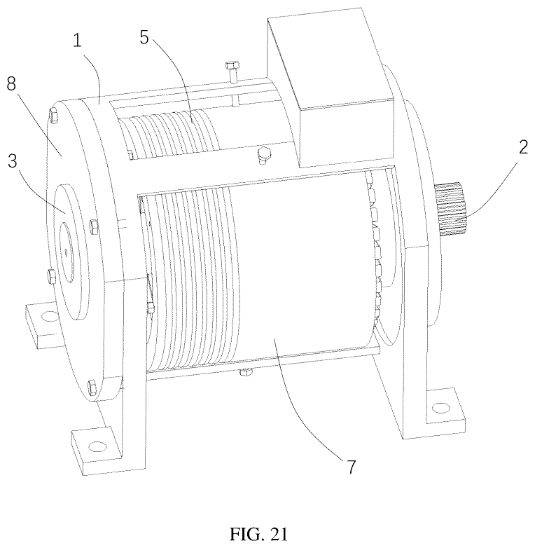

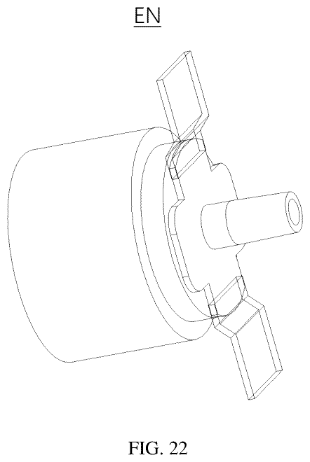

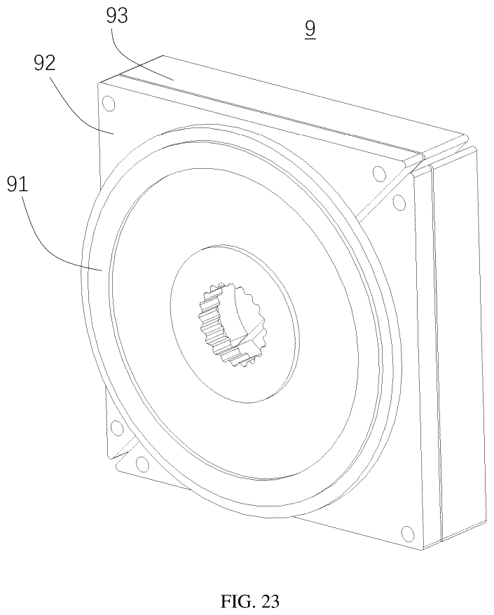

FIG. 13 is a flow diagram of an assembly method according to the present disclosure; FIG. 14 is an assembly diagram of a sheave and a pulley according to the present disclosure; FIG. 15 is an assembly diagram of an assembly based on FIG. 14 and a rotating shaft according to the present disclosure; FIG. 16 is an assembly diagram of an assembly based on FIG. 15 and a first rolling bearing and a second rolling bearing according to the present disclosure; FIG. 17 is an assembly diagram of an assembly based on FIG. 16 and an end cover according to the present disclosure; FIG. 18 is a stereogram of a stator according to the present disclosure; FIG. 19 is a stereogram of a housing according to the present disclosure; FIG. 20 is an assembly diagram of a stator and a housing according to the present disclosure; FIG. 21 is an assembly diagram of a stator assembly and a rotor assembly according to the present disclosure; FIG. 22 is a stereogram of an encoder according to the present disclosure; FIG. 23 is a stereogram of a dual coil brake according to the present disclosure.

The present disclosure yet further relates to an assembly method for the aforementioned traction machine 111, comprising step A1: assembling a rotor assembly RA, step A2: assembling a stator assembly SA, and step A3: assembling the rotor assembly RA together with the stator assembly SA, wherein
the step A1 of assembling the rotor assembly RA comprises:
step A11: assembling the sheave 5 together with the pulley 7;
step A12: passing the rotating shaft 2 through the sheave 5 and the pulley 7;
step A13: mounting the first rolling bearing 3 and the second rolling bearing 4 onto the rotating shaft 2; and
step A14: mounting the end cover 8 onto the first rolling bearing 3; and the step A2 of assembling the stator assembly SA comprises:
step A21: mounting the stator 6 onto the support portion 11.

This assembly method involves assembling the rotor assembly and the stator assembly separately, and then combining the two into a traction machine, thereby achieving modular assembly. Such a clearly fined division of labor in the assembly process can improve assembly efficiency, reduce assembly errors, and facilitate management and organization on the production line. Based on the preceding interpretations of various technical solutions of the traction machine, this assembly method has significant advantages in aspects such as enhancing assembly efficiency, ensuring stable assembly of the rotor and stator assemblies, guaranteeing smooth operation, and providing protection, convenience, and coordination and consistency throughout the assembly. These technical effects collectively improve the performance, reliability, and service life of the traction machine.

If the traction machine further comprises an encoder and a coil brake, the assembly method may further include step A4 after step A3, i.e., assembling a rotor and stator assembly together with an encoder and a coil brake to form a traction machine.

To sum up, the traction machine of the present disclosure, with the design of a simply supported beam, an easily replaceable sheave, an outer rotor motor, and a coil brake, provides a traction machine structure that combines the advantages of both a cantilever beam and a simply supported beam.

The specific embodiments of the present disclosure as described above are only for the purpose of describing the principles of the present disclosure more clearly, wherein various components are clearly shown or described to make the principles of the present disclosure easier to understand. A person skilled in the art can easily make various modifications or changes to the present disclosure without departing from the scope of the present disclosure. Therefore, it should be understood that these modifications or changes should fall within the patent protection scope of the present disclosure.

What is claimed is:

1. A traction machine (111) for an elevator system (101), the traction machine (111) comprising:
a housing (1);
a rotating shaft (2) partially disposed within the housing (1) and axially extending outward through the housing (1);
a first rolling bearing (3) and a second rolling bearing (4) fitted onto the rotating shaft (2);
a sheave (5) disposed within the housing (1) and fitted around the rotating shaft (2), the sheave (5) being used for connecting ropes (107) of the elevator system (101), and the ropes (107) being used for connecting an elevator car (103) and a counterweight (105) of the elevator system (101),
wherein the sheave (5) is disposed between the first rolling bearing (3) and the second rolling bearing (4).

2. The traction machine (111) according to claim 1, wherein the traction machine (111) further comprises a stator (6) with coils and a pulley (7) with a magnet (71), wherein an end face of the housing (1) is configured with a support portion (11) axially extending inward, the stator (6) is fitted onto the support portion (11), the pulley (7) is fitted onto the rotating shaft (2) and fixedly connected with the sheave (5), and the magnet (71) is fitted around the stator (6).

3. The traction machine (111) according to claim 2, wherein the traction machine (111) further comprises an end cover (8), wherein the end cover (8) is snap-fit connected to the housing (1), the first rolling bearing (3) is radially disposed between the end cover (8) and the rotating shaft (2) and axially disposed within the end cover (8), and the second rolling bearing (4) is radially disposed between the housing (1) and the rotating shaft (2) and axially disposed within the housing (1).

4. The traction machine (111) according to claim 1, wherein the traction machine (111) further comprises a coil brake (9) comprising a friction disc (91) and a movable plate (92), wherein the friction disc (91) is fitted onto the rotating shaft (2) and connected to the rotating shaft (2) via splines, when the coil brake (9) is energized, the friction disc (91) is spaced apart from the movable plate (92), and when the coil brake (9) is de-energized, the friction disc (91) generates friction with the movable plate (92).

5. The traction machine (111) according to claim 3, wherein an end face of the sheave (5) is provided with a sheave through-hole (51), an end face of the pulley (7) is provided with a pulley blind hole (71), the sheave through-hole (51) is aligned with the pulley blind hole (71), and a threaded fastener (10) of the traction machine (111) extends through the sheave through-hole (51) into the pulley blind hole (71).

6. The traction machine (111) according to claim 1, wherein the traction machine (111) further comprises an encoder (EN), wherein the encoder (EN) is plug-connected to an end face of the rotating shaft (2), and the encoder (EN) is used to measure the rotational speed of the rotating shaft (2).

7. The traction machine (111) according to claim 3, wherein the end face of the housing (1) facing the end cover (8) is configured with a first stepped portion (12), and the end cover (8) is snap-fit engaged with the first stepped portion (12).

8. The traction machine (111) according to claim 2, wherein the support portion (11) is configured with a second stepped portion (112), the end of the rotating shaft (2) away from the first rolling bearing (3) is configured with a third stepped portion (21), and the second rolling bearing (4) is radially disposed between the second stepped portion (112) and the third stepped portion (21).

9. The traction machine (111) according to claim 2, wherein the end of the pulley (7) facing the sheave (5) is configured as a frame structure (72), the frame structure (72) comprising an axially extending hollow cylinder (721) and a rib portion (722) extending radially outward from the hollow cylinder (721) to the inner circumferential surface of the pulley (7), and the rotating shaft (2) is configured with a fourth stepped portion (22), with the hollow cylinder (721) abutting against the fourth stepped portion (22).

10. The traction machine (111) according to claim 1, wherein the end of the rotating shaft (2) facing the first rolling bearing (3) is configured with a fifth stepped portion (23), with the first rolling bearing (3) abutting against the fifth stepped portion

(23) .

11. The traction machine (111) according to claim 3, wherein the end cover (8) comprises an end cover body (81) and an accommodating portion (82) extending axially inward and outward relative to the end cover body (81), wherein the axially outer part of the accommodating portion (82) relative to the end cover body (81) extends radially toward the rotating shaft (2), and the first rolling bearing (3) is disposed within the accommodating portion (82), and the end cover (8) further comprises a snap-fit portion (83) extending axially inward from the end cover body (81), with the snap-fit portion (83) snap-fit connected to the housing (1).

12. An elevator system (101), wherein the elevator system (101) comprises the traction machine (111) according to claim 1.

13. A sheave maintenance method for the traction machine (111) according to claim 5, wherein the sheave maintenance method comprises:
extending a bolt (B) via the housing (1) into the pulley (7);
dismounting the end cover (8);
loosening the threaded fastener (10);
abutting a push rod (R) of a sheave maintenance tool (T) against an end face of the rotating shaft (2);
engaging an engaging bolt (T1) of the sheave maintenance tool (T) into a maintenance hole (52) provided on the end face of the sheave (5), and abutting the engaging bolt (T1) against the end face of the pulley (7) via the maintenance hole (52); and
rotating the push rod (R), and pulling out the sheave (5).

14. The sheave maintenance method according to claim 13, wherein the sheave maintenance method further comprises:
engaging the engaging bolt (T1) to the maintenance hole (52);
mounting the sheave (5) onto the pulley (7);
loosening the engaging bolt (T1) and removing the sheave maintenance tool (T);
extending the threaded fastener (10) through the sheave through-hole (51) into the pulley blind hole (71);
mounting the end cover (8); and
removing the bolt (B).

15. An assembly method for the traction machine (111) according to claim 3, wherein the assembly method comprises assembling a rotor assembly (RA), assembling a stator assembly (SA), and assembling the rotor assembly (RA) together with the stator assembly (SA), wherein
assembling the rotor assembly (RA) comprises:
assembling the sheave (5) together with the pulley (7);
passing the rotating shaft (2) through the sheave (5) and the pulley (7);
mounting the first rolling bearing (3) and the second rolling bearing (4) onto the rotating shaft (2); and
mounting the end cover (8) onto the first rolling bearing (3); and
the step of assembling the stator assembly (SA) comprises:
mounting the stator (6) onto the support portion (11).
